(19) United States
(12) Patent Application Publication
(10) Pub. No.: US 2013/0223972 A1
(43) Pub. Date: Aug. 29, 2013

(54) METHOD AND APPARATUS FOR LOADING AND UNLOADING AN ATV

(71) Applicant: Kenny Randall Eng, Elkford (CA)

(72) Inventor: Kenny Randall Eng, Elkford (CA)

(21) Appl. No.: 13/779,145

(22) Filed: Feb. 27, 2013

Related U.S. Application Data
(60) Provisional application No. 61/604,300, filed on Feb. 28, 2012.

(30) Foreign Application Priority Data
Feb. 28, 2012 (CA) 2769806

(51) Int. Cl. B60P 1/43

(52) U.S. Cl. CPC B60P 1/43
USPC 414/812; 248/499

(57) ABSTRACT

The method and apparatus for loading and unloading an ATV from a truck bed includes mounting a sling in the forward end of the truck bed and attaching the winch line from the ATV to the sling link of the sling. With a pair of loading ramps inclined from the ground up to the rear end of the truck box, the winch line is used to winch the ATV up the ramps, or to assist the ATV in its self-propelled driving up the ramps and onto the truck bed. When unloading the ATV, the ATV is driven rearwardly down the ramps while the winch line is simultaneously extended from the winch so as to act as a speed limiter and to help keep the front of the ATV from lifting off the ramps.

### FIELD OF THE INVENTION

This invention relates to the field of safety devices and in particular to devices for loading and unloading wheeled objects into the beds of trucks such as pickup trucks.

### BACKGROUND OF THE INVENTION

Applicant is personally familiar with the potential danger associated with loading all terrain vehicles (ATV's) and like powered recreational vehicles into the beds on the back of conventional pick-up trucks by the use of conventionally available loading ramps. As will be understood by those skilled in the art, the beds of pick-up trucks are sufficiently high to clear the drive train and frame of the pick-up vehicle and consequently the tailgate of the pick-up truck bed is also at that relatively high elevation so that when loading the bed of the pick-up truck, the load must be elevated for insertion into the bed. In the case of ATV's, snowmobiles and the like, the loading of the pick-up truck bed often entails the use of loading ramps so that the ATV, snowmobile, etc, under its own power, maybe driven up the loading ramp and onto the pick-up truck bed.

What differs between conventional ATV's and snowmobiles, is that quite often and in applicant's experience, an ATV will have or may be equipped with a winch on the front of the ATV. ATV's are often used as utility vehicles, for example are used to carry a load on a rack mounted on the ATV. Such racks are typically above the front or rear wheels of the ATV. The driver of the ATV sits typically positioned midway between the front and rear wheels of the vehicle. Consequently, as the ATV is driven up a steep inclined plane such as presented by conventional loading ramps, the centre of gravity of the ATV may become dangerously close to tipping the ATV over rearwardly, ie backwards over its rear wheels. This is especially true if a load is being carried on the rear rack of the ATV, which may shift the centre of gravity of the ATV and its load to the rear of the balance point of the ATV about its rear wheels as the ATV is driven up the ramp. This causes the ATV to tip backwardly and risks the ATV falling on top of the driver. As ATVs can often weigh in the order of 1,000 lbs, if the ATV lands on its driver, injury to the driver is most likely. A further factor adding to the hazard posed by loading ATVs onto pickup trucks using loading ramps is that ATVs are often quite powerful and their throttles quite sensitive and hand or finger operated so that it is not uncommon in applicant's experience that operation of the throttle results in somewhat abrupt acceleration of the ATV as it is accelerated up the loading ramp, especially if driven by an inexperienced rider. This abrupt acceleration may displace the loading ramps, causing them to fall, or may cause the front of the ATV to rise which, again, moves the centre of gravity of the ATV to the rear which, added to the other factors set out above which also move the centre of gravity of the ATV rearward, may cause the ATV to tip up vertically or to tip the ATV over backwards over its rear wheels.

In the prior art, applicant is aware of the following United States patents which address securing cargo such as a vehicle in the bed of a pick-up truck or the like.

U.S. Pat. No. 7,901,168, which issued Mar. 8, 2011, to Fa-Kouri for a Cargo Anchoring System describes a cargo anchoring system for anchoring cargo to a cargo bed. The cargo anchoring system comprises a rear ring; a forward ring; and a ring connection member connecting the rear ring to the forward ring. A first lateral ring is sized and configured to be directly or indirectly attached to the cargo bed. A first lateral connection member connects the first lateral ring and the rear ring. A second lateral ring is sized and configured to be directly or indirectly attached to the cargo bed. A second lateral connection member connects the second lateral ring and the rear ring. A first elongate connection member is attached to the first lateral ring, and a second elongate connection member is attached to the second lateral ring. A front ring is sized and configured to be directly or indirectly attached to an item of cargo. Both elongate connection members are threaded through the forward ring and attached to the front ring. The cargo anchoring system further comprises either a hitch strap or a winch strap sized and configured to connect the rear ring to an item of cargo.

U.S. Pat. No. 5,846,047, which issued Dec. 8, 1998, to Riekki for a Motorcycle Loading Apparatus, describes an apparatus for loading a motorcycle onto another vehicle. The motorcycle loader comprises a wheel saddle positionable on a bed of the vehicle. A yoke assembly is connectable to front forks of the motorcycle. An auxiliary winch is mounted on the wheel saddle. A cable is connected to the yoke assembly. A remote control switch controls the winch. The remote control may be temporarily clamped into the handlebars of the motorcycle. An operator sitting on the motorcycle may energize the auxiliary winch by alternately pressing and releasing a push-button switch on the remote control. The winch thus gradually pulls the front wheel of the motorcycle into the wheel saddle so that the motorcycle can be subsequently tied down to the bed of the vehicle. A strap retainer for retaining a loose end of a strap in the yoke assembly is also provided.

United States patent application publication no. 2011/0123304, which was published May 26, 2011, for the invention of Thomas entitled Adjustable Winch Assembly And System For Loading Or Unloading Vehicles Onto Or From A Raised Bed or Deck describes a laterally adjustable winch assembly for loading and unloading an associated vehicle onto or from a raised deck of an associated carrier. The laterally adjustable winch assembly includes a first support member and a second support member slideably engaged with the first support member. The second support member includes a first attachment end and a second attachment end. The first and second attachment ends are configured to be detachably secured to a portion of the associated carrier. A retaining member is disposed between the first and second support members for selectively retaining the first support member in fixed relationship with the second support member. A winch is secured to the first support member. The winch includes a retractable winch line capable of being secured to the associated vehicle for winching the associated vehicle from a first level to a second raised level of the deck of the associated carrier. The first and second support members and the retaining member cooperate to allow the winch and winch line to be laterally adjusted with respect to the deck of the associated carrier so as to permit loading and unloading of the associated vehicle in a plurality of lateral positions. A system and method for loading and unloading are also provided.

U.S. Pat. No. 7,845,886, which issued Dec. 7, 2010, to Walker, III, for a Tiedown System describes a tiedown system having a single tensile member with cargo attachments on each end thereof. The tensile member passes through a series of guides affixed about the perimeter of the carrier (flatbed truck or trailer, etc.). The ends of the tensile member are secured removably to the rear of the cargo, e.g., the cargo rack of an all terrain vehicle (ATV). The medial portion of the tensile member is connected to a winch on the front of the ATV or other cargo, or alternatively the medial portion of the tensile member is passed through an opening on the front of the cargo, e.g., the forward cargo rack of the ATV, and connected to a winch anchored to the cargo bed of the carrier. The winch is actuated to draw up the tensile member, simultaneously pulling the rear and front of the cargo securely against the cargo bed of the carrier.

U.S. Pat. No. 6,524,056, which issued Feb. 25, 2003, to Kloster for a Motorcycle Loading, Unloading, Storage Apparatus, describes an apparatus for loading and unloading a motorcycle or similar vehicle onto and from the bed of a utility vehicle such as a pick-up truck which only requires a single operator. The apparatus comprises a guide rail subassembly secured to the bed of a utility vehicle, a main ramp subassembly detachably secured to the guide rail subassembly, a dolly subassembly which is adapted to support the motorcycle and ride on the main ramp subassembly and the guide rail subassembly. A plurality of adjustable tie down straps detachably secure the motorcycle to the dolly subassembly, and an approach ramp subassembly which is detachably secured to the dolly subassembly. The dolly subassembly has a winch and a battery mounted thereon with the battery powering the winch which has one end of a flexible cable secured thereto. A free end of the flexible cable has a hook secured thereto which is adapted to be attached to an eye bolt secured to the guide rail subassembly. The dolly also functions as a mobile base for movement of the dolly subassembly and the motorcycle secured thereto within confined areas for storage purposes.

U.S. Pat. No. 6,210,096, which issued Apr. 3, 2001, to Fielder for a Personal Watercraft Loading Apparatus, describes loading a personal watercraft in a bed of a truck. A skid is mounted on the bed of the truck with a mounting apparatus. Low friction bearings, preferably sheets of ultra high molecular weight plastic material, are provided between the skid and the bed of the truck and between the skid and the mounting brackets. The skid itself carries low friction bearings, again preferably in the form of components made of plastic material, so that the watercraft can easily slide up on to the skid. The skid is extended rearward in a telescoping fashion. The watercraft is brought toward the skid with the aid of a winch. The winch then pulls the watercraft onto the skid and pulls the skid and the watercraft into the bed of the truck.

U.S. Pat. No. 6,099,232, which issued Aug. 8, 2000, to Dixon for a Device For Loading A Small Vehicle Or Other Load Onto A Pickup Truck, describes a loading and unloading device for transporting small recreational or utility vehicles in a pickup truck. The invention comprises two stationary rails mounted on the bed of a truck. A ramp is slidably and pivotally attached to the stationary rails, and an interchangeable vehicle carriage or dump bed is slidably and pivotally mounted to the ramp. In use, the ramp and carriage are lowered by a winch so that the carriage is close to the ground and substantially horizontal. A small vehicle can then be placed on the carriage. A winch then pulls the carriage up the ramp until the vehicle's center of gravity is slightly rearward of the stationary rails. The carriage stops, and the winch pulls the ramp onto the stationary rails. The ramp can then be pushed into the bed of the truck.

U.S. Pat. No. 5,934,863, which issued Aug. 10, 1999, to Beck for a Vehicle Loading And Unloading Apparatus And Method, describes a personal vehicle loading and unloading apparatus. A support structure is mounted to a platform such as a truck bed which supports the personal vehicle. A moveable ramp is mounted telescopically within the support structure. The ramp is manually moveable between a retracted position where substantially the entire ramp is within the track bed and an extended position where substantially the entire ramp extends from the truck bed. The ramp and the support structure each have an upper surface over which the bottom surface of the personal vehicle, or a conveyor for the vehicle, rides as the personal vehicle is moved to and from the truck bed. A winch mechanism is mounted to the support structure to pull the personal vehicle into the truck bed during loading and lowers the personal vehicle from the truck bed during unloading.

U.S. Pat. No. 6,634,849, which issued Oct. 21, 2003, to Clary for a Motorcycle Loading And Unloading Device, describes a device for loading and unloading a motorcycle onto and from a transport surface of a vehicle. A dolly assembly has a plurality of spaced apart wheels. The wheels carry a frame structure that is adapted to support a front wheel of the motorcycle. The device also has a ramp assembly with a pivotable section. The ramp assembly has a loading surface. A first end is disposed near the transport surface. The pivotable section can be pivoted about the first end so that the opposite second end can be selectively raised and lowered. The device also has a winch mounted on a part of the vehicle.

The winch is operable to selectively load and unload the dolly assembly and motorcycle along the loading surface between the ground surface and the transport surface. The pivotable ramp section can be pivoted as the motorcycle and dolly transfer between the ramp assembly and the transport surface to prevent the motorcycle from bottoming out while transferring.

U.S. Pat. No. 6,827,543, which issued Dec. 7, 2004, to O'Neil for a Modular Motorcycle Stowing Device For A Truck Bed, describes a modular motorcycle stowing device for transporting a motorcycle in the bed of a pickup truck. A collapsible base fits on the floor of a pickup truck bed. A collapsible upper ramp is hingedly connected to the base and provides a guiding channel for receiving the front and rear tires of the motorcycle to be stowed in the device. In order to span the elevation between the ground and the pickup truck bed, a detachable loading ramp is provided and arranged for a sliding interfit into the upper ramp. Connected to the loading ramp is a footboard for supporting an assisting individual. Connected to the upper ramp is a winch which is used to assist in pulling the motorcycle up into the stowing device and for more controlled unloading of the motorcycle

U.S. Pat. No. 6,354,777, which issued Mar. 12, 2002, to Riekki for an Harness For Motorcycle Loading Apparatus, describes an apparatus for loading a motorcycle onto another vehicle. The motorcycle loader comprises a wheel saddle positionable on a bed of the vehicle. A yoke assembly is connectable to front forks of the motorcycle. An auxiliary winch is mounted on the wheel saddle and has a cable connected to the yoke assembly. A remote control switch controls the winch. The remote control may be temporarily clamped onto the handlebars of the motorcycle. An operator sitting on the motorcycle may energize the auxiliary winch by alternately pressing and releasing a push-button switch on the remote control. The winch thus gradually pulls the front wheel of the motorcycle into the wheel saddle so that the motorcycle can be subsequently tied down to the bed of the vehicle.

U.S. Pat. No. 6,089,816, issued on Jul. 18, 2000, to Christ for an Article Load Apparatus, describes an article load apparatus for loading and unloading articles, particularly motorized vehicles, onto a load carrying surface of another vehicle. The article load apparatus includes a mobile cart having a base for carrying an article. A power drive is mountable on the vehicle for moving the cart between a first position on the load carrying surface of the vehicle and a second position displaced from the load carrying surface. The cart is releasably lockable to a support member on the vehicle. A channel member is carried on the base for guiding and supporting an article. Tie down members on the base receive straps for securing an article to the cart. A chock is optionally mounted on the base for receiving a wheel of a wheeled article. A support frame is mountable on the vehicle and carries an electric motor driven winch having an extendable cable connectable to the base.

Applicant is also aware of U.S. Pat. Nos. 1,218,714 and 1,168,802 which show hoisting slings.

### SUMMARY OF THE INVENTION

The present invention may be characterized as including a method of, and apparatus for, loading and unloading an ATV from a truck bed, where the truck bed has a pair of tie-down mounting devices at laterally oppositely disposed front corners of the truck bed. The method includes the steps of:
a) providing a double leg sling having two similar-length, preferably identical-length, legs depending from a single sling link mounted at vertex ends of the legs, the sling having releasable fasteners such as hooks at the opposite free ends of the two legs, the legs of sufficient length to form a triangle when mounted to the tie-down devices in the truck bed and the sling link tensioned aft along the truck bed,
b) providing an ATV having a winch mounted to the front of the ATV, the winch including a selectively deployable and selectively retractable winch line having a hook on the distal end of the winch line and the winch being selectively actuable by a driver of the ATV,
c) fastening the releasable fasteners on the legs of the sling to the pair of tie-down mounting devices on the truck bed and thereby positioning the sling link between the pair of tie-down mounting devices, substantially on the longitudinal center-line of the truck bed,
d) providing ramps and positioning the ramps from the ground up to the truck bed, and positioning the ATV at the foot of the ramps with the ATV aligned with and facing the ramps,
e) deploying the winch line from the winch on the ATV up along the ramps and forwardly along the centerline of the truck bed and hooking the winch line hook onto the slink link,
f) retracting the winch line onto the winch either:
   (i) to draw the ATV, while in neutral gear, up along the ramps and along the centreline; or
   (ii) to retract the winch line onto the winch while simultaneously driving the ATV under its own power up the ramps and along the centerline of the truck bed,
      and continuing the retraction of the winch line onto the winch until the winch line is fully retracted and the sling link substantially snugged against the winch,
(g) for unloading the ATV, reversing steps d), e) and f) so as to deploy the winch line simultaneously as the ATV is reversed under its own power along the centerline and down the ramps while maintaining tension in the winch line, and once the ATV is on the ground detaching the winch line hook from the sling link and retracting the winch line onto the winch,
   wherein the legs of the sling are of sufficient length when tensioned by the winch line to position the sling link and ATV, when the sling link is snugged against the winch, with the rear of the ATV on the truck bed.

### BRIEF DESCRIPTION OF THE DRAWINGS

In the drawings wherein like reference numerals denote the corresponding parts in each view:

FIG. 1 is, in partially cutaway perspective view, an ATV being loaded or unloaded from the truck bed of a pickup truck.

FIG. 2 is a perspective view as seen by a driver of the ATV of FIG. 1 looking forwardly along the ATV and into the back of the pickup truck bed.

FIG. 3, is in plan view, a double-leg sling such as seen mounted in the forward end of the pickup truck bed of FIGS. 1 and 2.

FIG. 3a is, in plan view, an oval sling link according to a further embodiment of the sling of FIG. 3.

FIG. 3b is a round sling link according to a further embodiment of the sling of FIG. 3.

FIG. 4 is, in partially cutaway plan view, the sling of FIG. 3 as seen mounted in the truck bed of FIGS. 1 and 2, with the sling and winch line under tension.

FIG. 5 is a further embodiment of the sling according to another aspect of the present invention.

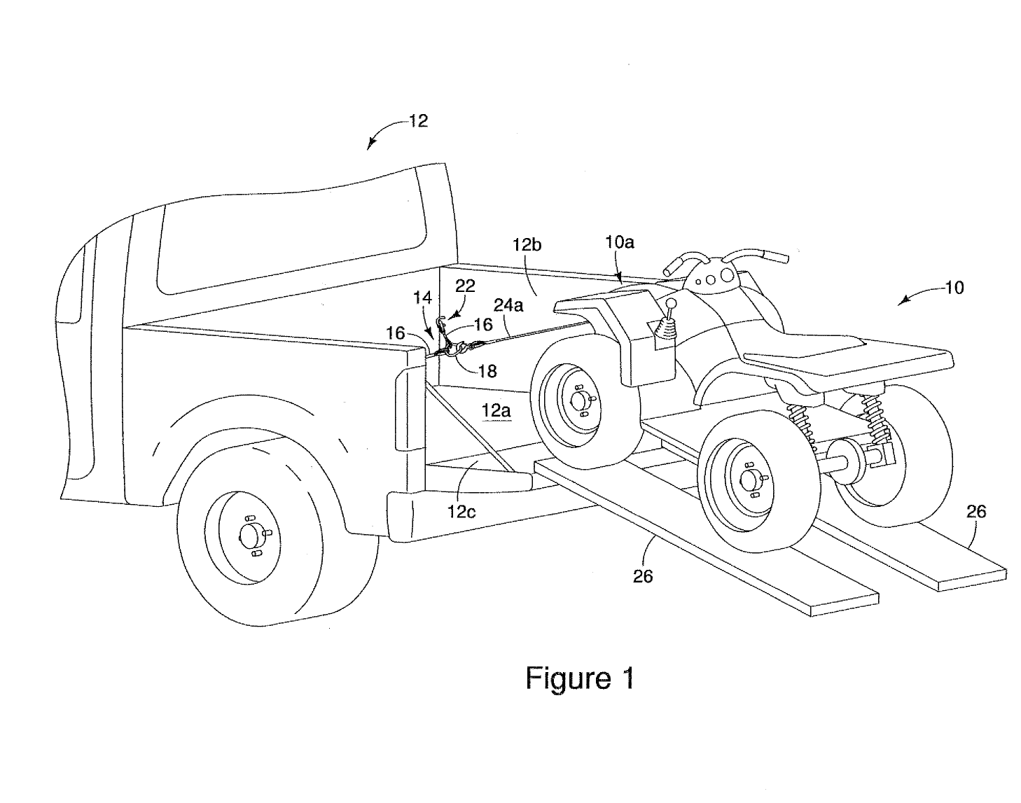

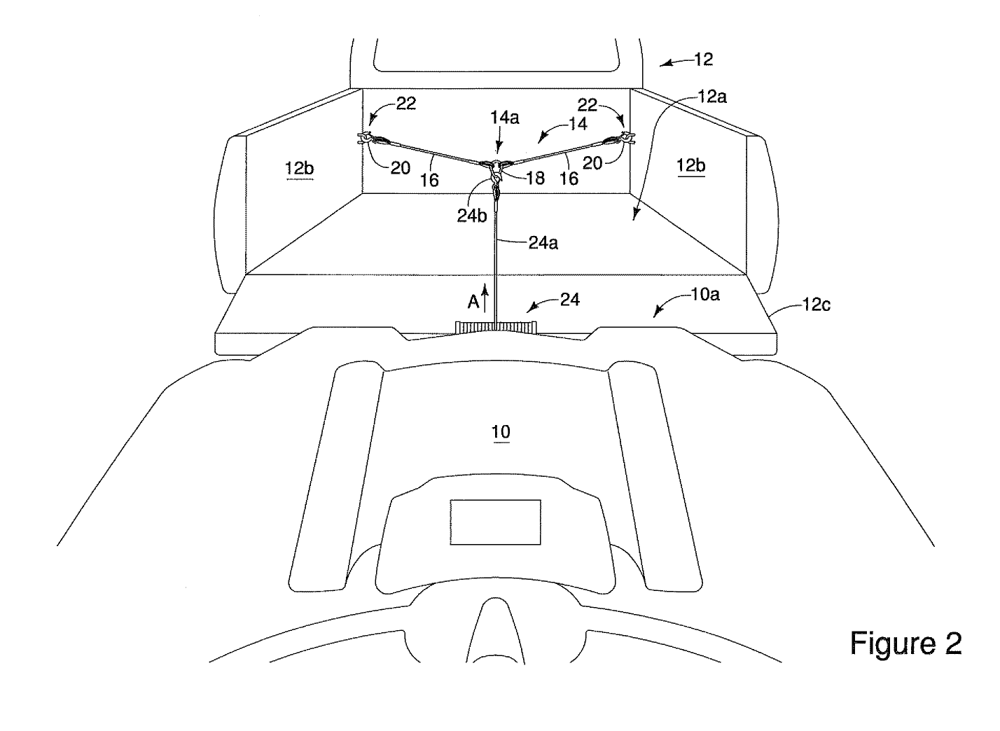

### DETAILED DESCRIPTION OF EMBODIMENTS OF THE INVENTION

The ATV loading system and method according to the present invention for loading ATV's 10 onto truck beds 12a, and for unloading them therefrom includes the use of a two-leg sling 14, that is, a sling 14 having two substantially identical legs 16, or at least two legs 16 of substantially the same length, mounted at the legs' vertex ends 16a to a single sling link 18. The opposite, free ends 16b of the two sling legs 16 each have a hook 20 or other releasable fastener mounted thereto. Sling 14 is for use in a truck bed 12a having mounting eyes 22 at the forward corners of the truck bed, such as now often conventionally found in pick-up trucks 12. With the hooks 20 mounted to mounting eyes 22, the sling link 18 at the vertex 14a of sling 14 mounts to a winch line 24a from the winch 24 on the front 100a of an ATV 10 being loaded onto or unloaded from the truck bed 12a.

The mounting eyes 22 may be inverted u-shaped members or other dedicated tie-down devices. The mounting eyes 22 are mounted typically to the inner wall of the sidewalls 12b of the pick-up truck bed 12a, or to the horizontal base surface of the bed for tying down loads. It is applicant's understanding that typical mounting eyes or tie-downs found in half-ton pick-up trucks, or in more heavy duty trucks, are intended by the truck manufacturer to withstand a tensile load of typically at least several hundred pounds of tension. These tie-down devices are adapted for the use of ropes or straps whether or not the ropes or straps have hooks on their ends or whether the straps or ropes themselves are hooked or passed through an eye in the tie-down device and then knotted.

Thus the tie-down devices in pickup truck beds are well suited for having the hooks 20 at the free ends 16b of a double-leg sling 14 temporarily mounted thereto. Such slings 14 are known in the prior art and commercially available widely. For example the Rigging.com Company, a Toolwell company, having a customer service center in Charlotte, N.C., USA, sells double-cable slings. A double cable sling typically may employ two lengths of wire cable where one end of each length of wire cable is mounted to a single master sling link, and the opposite free ends of the two cables have hooks mounted thereon. Thus when the hooks 20 on the ends of the pair of sling cables, that is, the hooks on the free ends of legs 16 are hooked into the tie-down mounting eyes 22 in the two forward corners of a pick-up truck bed 12a, that is, right behind the truck cab, and the sling 14 extended rearwardly along the bed, the master sling link 18 will be positioned, depending on the length of the lengths of cable, at approximately the centre of the bed and the pair of sling cables will form a triangular shape between the master sling link in the centre (the vertex of the triangular shape) and the two tie-down mounting eyes 22 at each front corner of the bed 12a.

Applicant has determined that, with the sling thus positioned, the winch line 24a from the ATV 10 may be deployed from the winch 24 and the winch line hook 24b hooked onto sling link 18. This may be done with the ATV is positioned at the foot of a pair of loading ramps 26 leading up onto the tailgate 12c of the truck. With the winch line thus extended into the truck bed and hooked to the sling link at the vertex of the tensioned sling, the ATV may be either driven up the ramps under its own motor power while simultaneously drawing in the winch line onto the winch to maintain tension in the winch line. Alternatively, the winch alone may be used to pull the ATV, once put into its neutral gear, up along the ramps, over the tailgate and into the truck bed. The latter approach is, in applicant's opinion, safer because it avoids the abrupt acceleration of the ATV referred to above which may cause the front wheels of the ATV to rise up off the loading ramps.

However, applicant has determined that when loading the ATV using the winch alone, surprisingly high tensile loads are generated acting on the sling. Applicant believes that this is because the high angle of the loading ramps, combined with the significant weight of the ATV mean that, at the outset of pulling the ATV up the ramps, as the winch line passes up over the tailgate, the winch is not only pulling the vector component of the weight of the ATV up the inclined ramps, but also, because of the angle of the winch line relative to the angle of the loading ramps, pulling the ATV against the loading ramps rather than merely along the loading ramps. This apparently adds significantly to the tensile load acting on the winch line and sling.

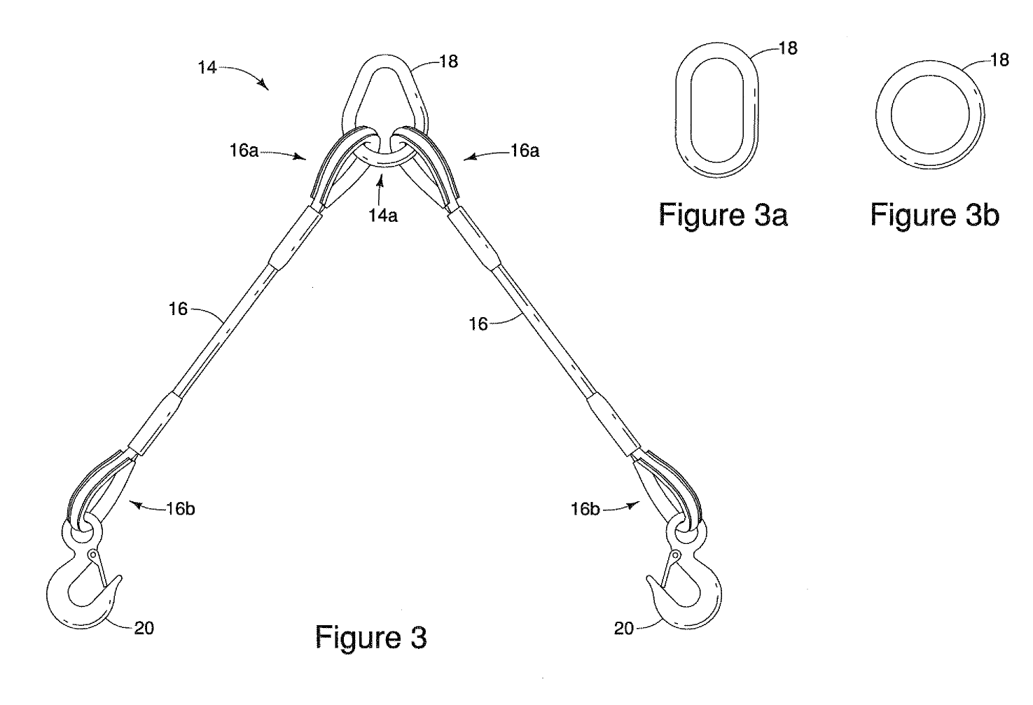

Advantageously the sling may use various forms of the sling link 18, legs 16 and hooks 20. For instance, sling link 18 may be triangular as seen in FIG. 3, or may be oval as seen in FIG. 3a or for example round as seen in FIG. 3b, and in either embodiment may be constructed of ⅜ inch, ½ inch or ⅝ inch diameter stock for example, and may for example be of stainless steel.

Legs 16 may be cable, for example ¼ inch or 5/16 inch, or synthetic rope, for example ¼ inch, or chain, for example ½ inch nominal diameter link stock. In the case of cables the looped ends at ends 16a and 16b may be constructed using wire rope thimbles matching the cable diameter and secured using duplex or oval swage sleeves as would be known to one skilled in the art. In the case of synthetic rope, the ends 16a and 16b may be spliced as would be known to one skilled in the art. In the case of chain, sling link 18 and hooks 20 may be mounted at ends 16a and 16b respectively using detachably mountable links or fasteners as would be known to one skilled in the art, so long as the tension loading can be safely accommodated.

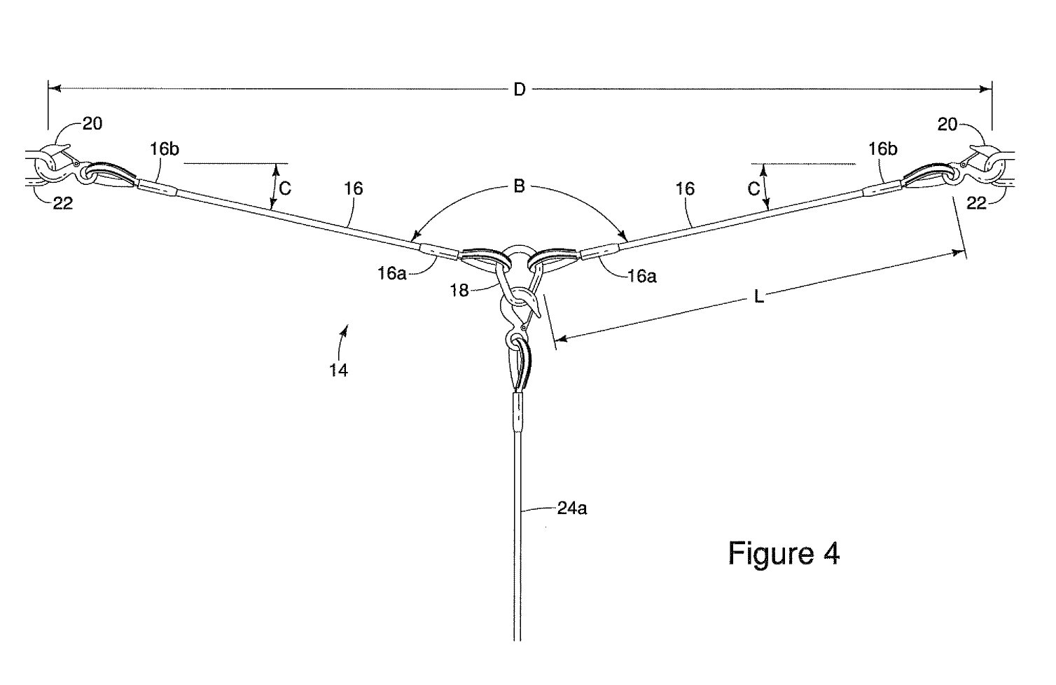

As seen in FIG. 4, in one preferred embodiment, when the sling is mounted in the truck bed and the sling tensioned by the winch line 24a, the angle B formed between the two legs may be in the order of 140-160 degrees, and the oppositely disposed included angles C thus 10-20 degrees. For example then, for use in a truck bed which has a nominal width D of about 62-64 inches wide (or for example where D is 69 inches for a one ton truck), the length L of each leg may be approximately 32 inches long. An angle B of 140 degrees and angles C of 20 degrees are preferred so as to provide Occupational Safety and Health Administration (OSHA) recommended working load limits (WLL) ratio of 5:1 for a nominal ATV weight of 1,000 lbs.

Applicant has determined that, once the ATV crests the top of the loading ramp as it moves in direction A into a horizontal position loading onto bed 12a of truck 12, the tensile loads decrease from those encountered during hauling of the ATV up the loading ramps. The lengths of the sling legs 16 may advantageously be of sufficient length to properly position the ATV within the box of the pick-up truck as sling link 18 is drawn up to winch 24, that is, as the winch line 24a is completely retracted onto winch 24. Thus the user merely waits until the winch stops, as it does when the winch line is completely retracted, and knows that, at that position, the ATV is best positioned on the bed within the pick-up truck box for travel. Further, the user, without anything further knows that the ATV is securely fastened within the pick-up truck box without the need for further tethering of the front of the ATV to the truck. Tie down straps or the like may then be used to secure the rear of the ATV for travel.

For unloading the ATV from the pick-up truck bed, the ATV may be reversed under its own power and backed from the tailgate down along the loading ramps as the winch line is simultaneously deployed so that, if inadvertently the front end of the ATV starts to rise from the ramps, the winch line will become tensioned thereby stopping further lifting of the front of the ATV. Thus extraction of the ATV from the pick-up truck is also enabled using the system according to the present invention without the user having to do anything other than back the ATV in reverse as ordinarily would be done during unloading while simultaneously letting out the winch line from the winch. Typically winch operation may be done with a single toggled switch on the ATV. Thus the speed of reversing the ATV from the pick-up truck bed is merely matched to the speed of the deployment of the winch line from the winch. Thus, even if the throttle over accelerates the ATV in reverse, the winch acts as a speed governor and will only allow the winch line to deploy at substantially a single rate. If deployment of the winch line is forced, the deployment speed of the winch will brake the rearward acceleration of the ATV. Consequentially the system allows for improved safety of, not only loading, but also unloading of the ATV.

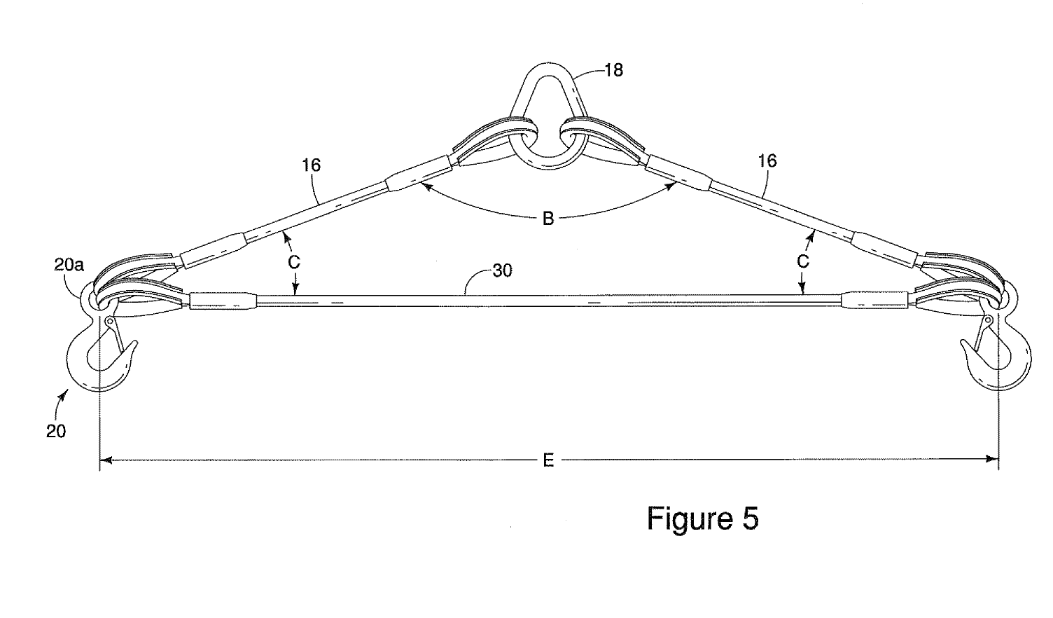

In the embodiment of FIG. 5, an additional flexible member, referred to as an angular stress controller (ASC) 30, is mounted between hooks 20. ASC 30 controls the shape of the triangle formed by legs 16 and ASC 30 so that angles C are maintained at or substantially at least at 20 degrees. In the example of FIG. 4, ASC 30 would be approximately 56-66 inches long (length E in FIG. 5), depending on the lengths of legs 16. In one preferred embodiment, ASC may be made of 4 inch cable. The inch cable may be vinyl covered cable. The ends of ASC 30 may be attached to hooks 20 by forming eyes at each end of the cable using, for example, standard thimbles and so-called Flemish Eye steel swaging available from the supplier Alibaba (www.alibaba.com).

The eyes 20a of hooks 20 will thus each have to be large enough to accommodate two thimbles (one for cable 16, and one for ASC 30). Applicant has successfully used ¾ Ton and 1 Ton galvanized drop-forged safety swivel hooks available from Fastenal (www.fastenal.com).

The inclusion of ASC 30 forces users to use the appropriate sling for their truck bed so as to maintain the proper angles C according to OSHA WLL limits. If, using the ASC 30, sling 14 doesn't fit across the truck bed from eye 22 to eye 22, then the sling is not the proper one for the bed width.

Alternatively the ATV loading safety line system according to the present invention will work without the truck built-in front cargo tie-downs. Instead, on the truck box top rail slot use a keeper stake pocket tie down (not shown) rated for a minimum of 1000 pounds.

Also alternatively, the operator may stand on the ground off to a side of the loading ramps while using a remote winch control to load or unload the ATV in a smooth, controlled manner if the ATV is equipped with a remote control winch.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for loading and unloading an ATV from a truck bed, where the truck bed has a pair of tie-down mounting devices at laterally oppositely disposed front corners of the truck bed. The method includes the sequential steps of:
a) providing a double leg sling having two legs of substantially the same length mounted to one another by a single sling link mounted at vertex ends of the legs so as to form a vertex between said legs, the sling having releasable fasteners mounted on opposite free ends of said legs, opposite to said vertex ends, wherein said length of said legs are sufficient to form a triangle having a vertex included angle and oppositely disposed, opposed facing, free-end included angles when said sling is mounted to the tie-down devices in the truck bed and said sling link is tensioned aft substantially horizontally along the truck bed,
b) providing an ATV having a winch mounted to the front of the ATV, wherein said winch includes a selectively deployable and selectively retractable winch line having a hook on the distal end thereof and the winch wherein actuation of said winch is selectively actuable by a driver sitting on the ATV,
c) fastening said releasable fasteners on said legs of said sling to the pair of tie-down mounting devices on the truck bed and thereby positioning said sling link between the pair of tie-down mounting devices, substantially on a longitudinally extending center-line of the truck bed,
d) providing ramps and positioning the ramps so as to be inclined at a loading angle up from the ground up to the aft end of the truck bed, and positioning the ATV at the foot of the ramps with the ATV aligned with and facing up the inclined ramps,
e) deploying the winch line from the winch on the ATV up along the inclined ramps and forwardly along the centerline of the truck bed, and hooking the winch line hook onto said sling link,
f) retracting said winch line onto said winch simultaneously with the ATV being driven forward under its own power at a speed substantially equivalent to a retraction speed of said winch or with the ATV in neutral gear so as to be entirely pulled up said inclined ramps by said retraction of said winch line onto said winch.
g) continuing said retraction of said winch line onto said winch until said winch line is fully retracted and said sling link is substantially snugged against said winch,
wherein said length of said legs forms said free end included angles in substantially the range of 10-30 degrees,
whereby the rear of the ATV is drawn up onto the truck bed and off the inclined ramps.

2. The method of claim 1 wherein, to unload the ATV, said winch line is deployed simultaneously as the ATV is reversed under its own power along the centreline of the truck bed and down the inclined ramps while maintaining tension in the winch line, and once the ATV is on the ground detaching the winch line hook from the sling link and retracting the winch line onto the winch,

3. The method of claim 1 further comprising providing a flexible, angular stress control member mounted to, so as to extend between, said free ends of said legs, wherein said member is of a pre-determined length so that, when said legs and said members are taut, said free-end included angles are maintained at a preferred angle within said 10-30 degree range.

4. The method of claim 1 wherein said free-end included angles are each substantially no less than 20 degrees.

5. The method of claim 4 wherein said free-end included angles are each substantially 20 degrees.

6. The method of claim 3 wherein said free-end included angles are each substantially no less than 20 degrees.

7. The method of claim 6 wherein said free-end included angles are each substantially 20 degrees.

8. The method of claim 6 wherein said legs of said sling and said member are cables, and wherein said releasable fasteners are hooks.

9. The method of claim 2 further comprising providing a flexible, elongate, angular stress control member mounted to, so as to extend between, said free ends of said legs, wherein said member is a pre-determined length so that, when said legs and said member are taut, said free-end included angles are maintained at a preferred angle within said 10-30 degree range.

10. The method of claim 2 wherein said free-end included angles are each substantially no less that 20 degrees.

11. The method of claim 10 wherein said free-end included angles are each substantially 20 degrees.

12. The method of claim 9 wherein said free-end included angles are each substantially no less than 20 degrees.

13. The method of claim 12 wherein said free-end included angles are each substantially 20 degrees.

14. The method of claim 12 wherein said legs of said sling and said member are cables, and wherein said releasable fasteners are hooks.

15. The sling of claim 1, further comprising providing a flexible, angular stress control member mounted to, so as to extend between, said free ends of said legs, wherein said member is of a pre-determined length so that, when said legs and said members are taut, said free-end included angles are maintained at a preferred angle within said 10-30 degree range.

16. The sling of claim 15 wherein said free-end included angles are each substantially no less than 20 degrees.

17. The sling of claim 16 wherein said free-end included angles are each substantially 20 degrees.

18. The sling of claim 17 wherein said legs of said sling and said member are cables, and wherein said releasable fasteners are hooks.
